(19) United States
(12) Patent Application Publication
(10) Pub. No.: US 2016/0270028 A1
(43) Pub. Date: Sep. 15, 2016

(54) METHOD AND APPARATUS FOR TRANSMITTING PAGING MESSAGE IN WIRELESS COMMUNICATION SYSTEM

(71) Applicant: LG ELECTRONICS INC., Yeongdeungpo-gu, Seoul (KR)

(72) Inventors: Jaewook LEE, Seoul (KR); Youngdae LEE, Seoul (KR); Sunghoon JUNG, Seoul (KR)

(73) Assignee: LG ELECTRONICS INC., Seoul (KR)

(21) Appl. No.: 15/033,379

(22) PCT Filed: Oct. 29, 2014
(86) PCT No.: PCT/KR2014/010248

§ 371 Date: Apr. 29, 2016

Related U.S. Application Data
(60) Provisional application No. 61/898,482, filed on Nov. 1, 2013.

(51) Int. Cl. H04W 68/02; H04W 4/00; H04W 76/02; H04W 72/04

(52) U.S. Cl. CPC H04W 68/02; H04W 72/0406; H04W 4/005; H04W 76/022; H04W 88/08

(57) ABSTRACT

A method and apparatus for transmitting a paging message in a wireless communication system is provided. A mobility management entity (MME) transmits a paging message, which includes an indication of user equipment (UE) capability for paging, to an eNodeB (eNB). The indication of UE capability for paging indicates whether a UE to be paged is a category 0 UE. The category 0 UE has a single receive antenna, and supports a transport block size (TBS) of maximum 1000 bits for a unicast uplink shared channel (UL-SCH) transmission or a unicast downlink shared channel (DL-SCH) reception. Upon receiving the UE capability for paging, the eNB transmits a paging message to a user equipment (UE) based on the UE capability for paging.

### TECHNICAL FIELD

The present invention relates to wireless communications, and more particularly, to a method and apparatus for transmitting a paging message in a wireless communication system.

### BACKGROUND ART

Universal mobile telecommunications system (UMTS) is a 3^{rd} generation (3G) asyn-chronous mobile communication system operating in wideband code division multiple access (WCDMA) based on European systems, global system for mobile communications (GSM) and general packet radio services (GPRS). A long-term evolution (LTE) of UMTS is under discussion by the 3^{rd} generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

In 3GPP LTE, user equipments (UEs) may be paged by a network. A paging message is transmitted over all cells belonging to the same tracking area (TA). In perspective of the core network, the purpose of the paging procedure is to enable an mobility management entity (MME) to page a UE in the specific eNodeB (eNB). In perspective of eNB, the purpose of paging procedure is to transmit paging rmation to a UE in an radio resource control (RRC) idle mode and/or, to rm UEs in RRC idle mode and UEs in RRC connected mode about a system rmation change and/or, to nn about an earthquake and tsunami warning system (ETWS) primary notification and/or ETWS secondary notification and/or, to rm about a commercial mobile alert system (CMAS) notification. The paging rmation is provided to upper layers, which in response may initiate RRC connection establishment, e.g., to receive an incoming call.

Low complexity UEs are targeted to low-end (e.g., low average revenue per user, low data rate, delay tolerant) applications, e.g., some machine-type communications. Low complexity UEs may be called category 0 UEs. According to characteristic of category 0 UEs, the conventional paging procedure may not work well for the category OUEs. Therefore, a method for paging category 0 UEs efficiently may be required.

### SUMMARY OF INVENTION

### Technical Problem

The present invention provides a method and apparatus for transmitting a paging message in a wireless communication system. The present invention provides a method for transmitting a paging message for category 0 user equipments (UEs), which are in a radio resource control (RRC) idle mode and have lower performance than general UEs. The present invention provides a method for transmitting, by a core network, information on paging of category 0 UEs to an eNodeB (eNB).

### Solution to Problem

In an aspect, a method for transmitting, by a mobility management entity (MME), a paging message in a wireless communication system is provided. The method includes transmitting a paging message, which includes an indication of user equipment (UE) capability for paging, to an eNodeB (eNB). Te indication of UE capability for paging indicates whether a UE to be paged is a category 0 UE. The category 0 UE may have a single receive antenna, and supports a transport block size (TBS) of maximum 1000 bits for a unicast uplink shared channel (UL-SCH) transmission or a unicast downlink shared channel (DL-SCH) reception.

In another aspect, a method for transmitting, by an eNodeB (eNB), a paging message in a wireless communication system is provided. The method includes receiving a first paging message, which includes an indication of user equipment (UE) capability for paging, from a mobility management entity (MME), and transmitting a second paging message to the UE based on the indication of UE capability for paging. The indication of UE capability for paging indicates whether a UE to be paged is a category 0 UE.

In another aspect, an eNodeB (eNB) in a wireless communication system is provided. The eNB includes a radio frequency (RF) unit for transmitting or receiving a radio signal, and a processor coupled to the RF unit, and configured to receive a first paging message, which includes an indication of user equipment (UE) capability for paging, from a mobility management entity (MME), and transmit a second paging message to the UE based on the indication of UE capability for paging. The indication of UE capability for paging indicates whether a UE to be paged is a category 0 UE.

### Advantageous Effects of Invention

A network can page category 0 UEs efficiently.

### BRIEF DESCRIPTION OF DRAWINGS

FIG. 1 shows LTE system architecture.

FIG. 2 shows a block diagram of architecture of a typical E-UTRAN and a typical EPC.

FIG. 3 shows a block diagram of a user plane protocol stack and a control plane protocol stack of an LTE system.

FIG. 4 shows an example of a physical channel structure.

FIG. 5 shows a paging procedure between an MME and an eNB.

FIG. 6 shows a paging procedure between an E-UTRAN and a UE.

FIG. 7 shows an example of a method for transmitting a paging message according to an embodiment of the present invention.

FIG. 8 shows another example of a method for transmitting a paging message according to an embodiment of the present invention.

FIG. 9 is a block diagram showing wireless communication system to implement an embodiment of the present invention.

### MODE FOR THE INVENTION

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802.20, evolved UTRA (E-UTRA), etc. IEEE 802.16m is evolved from IEEE 802.16e, and provides backward compatibility with a system based on the IEEE 802.16e. The UTRA is a part of a universal mobile telecommunication system (UMTS). 3^{rd} generation partnership project (3GPP) long term evolution (LTE) is a part of an evolved UMTS (E-UMTS) using the E-UTRA. The 3GPP LTE uses the OFDMA in a downlink and uses the SC-FDMA in an uplink LTE-advanced (LTE-A) is an evolution of the LTE.

For clarity, the following description will focus on LTE-A. However, technical features of the present invention are not limited thereto.

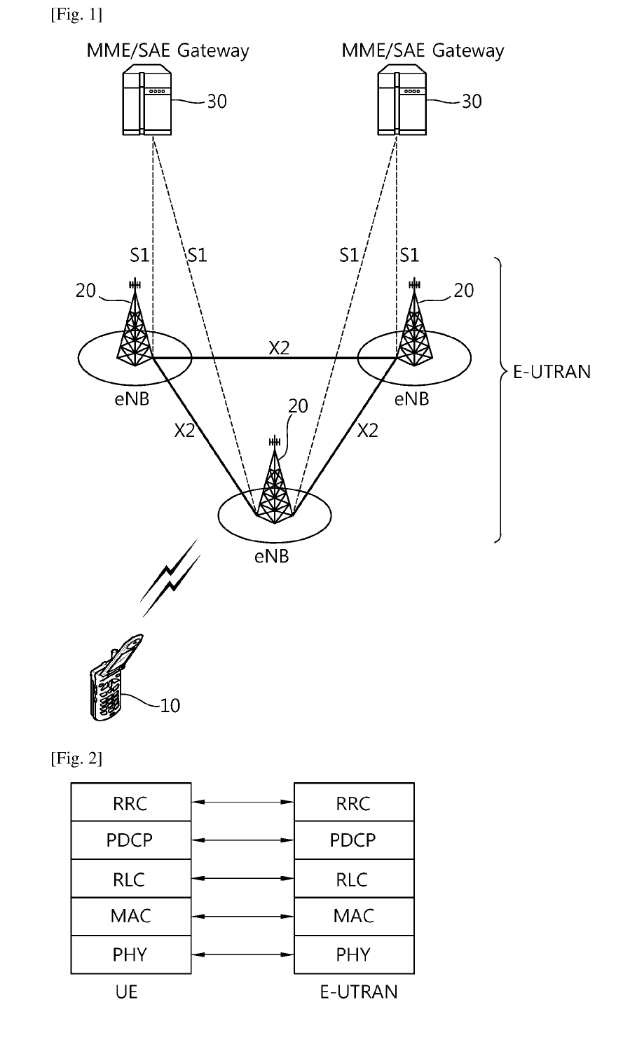

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), a base transceiver system (BTS), an access point, etc. One eNB 20 may be deployed per cell. There are one or more cells within the coverage of the eNB 20. A single cell is configured to have one of bandwidths selected from 1.25, 2.5, 5, 10, and 20 MHz, etc., and provides downlink or uplink transmission services to several UEs. In this case, different cells can be configured to provide different bandwidths.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) which is in charge of control plane functions, and a system architecture evolution (SAE) gateway (S-GW) which is in charge of user plane functions. The MME/S-GW 30 may be positioned at the end of the network and connected to an external network. The MME has UE access information or UE capability information, and such information may be primarily used in UE mobility management. The S-GW is a gateway of which an endpoint is an E-UTRAN. The MME/S-GW 30 provides an end point of a session and mobility management function for the UE 10. The EPC may further include a packet data network (PDN) gateway (PDN-GW). The PDN-GW is a gateway of which an endpoint is a PDN.

The MME provides various functions including non-access stratum (NAS) signaling to eNBs 20, NAS signaling security, access stratum (AS) security control, Inter core network (CN) node signaling for mobility between 3GPP access networks, idle mode UE reachability (including control and execution of paging retransmission), tracking area list management (for UE in idle and active mode), P-GW and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on APN-AMBR. For clarity MME/S-GW 30 will be referred to herein simply as a “gateway,” but it is understood that this entity includes both the MME and S-GW.

Interfaces for transmitting user traffic or control traffic may be used. The UE 10 and the eNB 20 are connected by means of a Uu interface. The eNBs 20 are interconnected by means of an X2 interface. Neighboring eNBs may have a meshed network structure that has the X2 interface. The eNBs 20 are connected to the EPC by means of an S1 interface. The eNBs 20 are connected to the MME by means of an S1-MME interface, and are connected to the S-GW by means of S1-U interface. The S1 interface supports a many-to-many relation between the eNB 20 and the MME/S-GW.

FIG. 2 shows a block diagram of architecture of a typical E-UTRAN and a typical EPC. Referring to FIG. 2, the eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

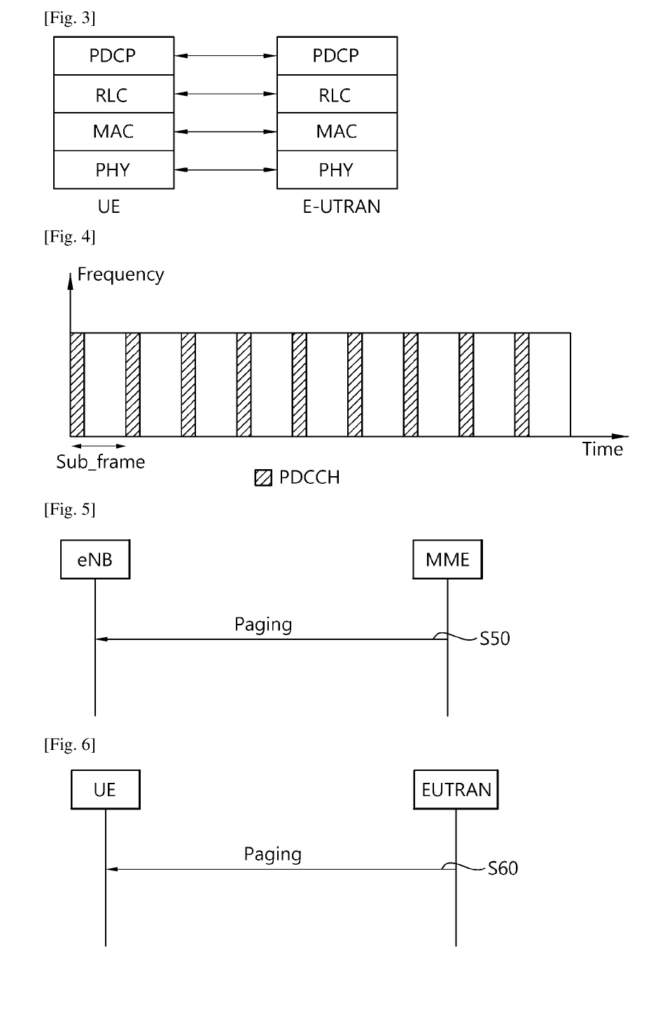

FIG. 3 shows a block diagram of a user plane protocol stack and a control plane protocol stack of an LTE system. FIG. 3-(a) shows a block diagram of a user plane protocol stack of an LTE system, and FIG. 3-(b) shows a block diagram of a control plane protocol stack of an LTE system.

Layers of a radio interface protocol between the UE and the E-UTRAN may be classified into a first layer (L1), a second layer (L2), and a third layer (L3) based on the lower three layers of the open system interconnection (OSI) model that is well-known in the communication system. The radio interface protocol between the UE and the E-UTRAN may be horizontally divided into a physical layer, a data link layer, and a network layer, and may be vertically divided into a control plane (C-plane) which is a protocol stack for control signal transmission and a user plane (U-plane) which is a protocol stack for data information transmission. The layers of the radio interface protocol exist in pairs at the UE and the E-UTRAN, and are in charge of data transmission of the Uu interface.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data is transferred between the MAC layer and the PHY layer through the transport channel. Between different PHY layers, i.e., a PHY layer of a transmitter and a PHY layer of a receiver, data is transferred through the physical channel using radio resources. The physical channel is modulated using an orthogonal frequency division multiplexing (OFDM) scheme, and utilizes time and frequency as a radio resource.

The PHY layer uses several physical control channels. A physical downlink control channel (PDCCH) reports to a UE about resource allocation of a paging channel (PCH) and a downlink shared channel (DL-SCH), and hybrid automatic repeat request (HARQ) information related to the DL-SCH. The PDCCH may carry a UL grant for reporting to the UE about resource allocation of UL transmission. A physical control format indicator channel (PCFICH) reports the number of OFDM symbols used for PDCCHs to the UE, and is transmitted in every subframe. A physical hybrid ARQ indicator channel (PHICH) carries an HARQ acknowledgement (ACK)/non-acknowledgement (NACK) signal in response to UL transmission. A physical uplink control channel (PUCCH) carries UL control information such as HARQ ACK/NACK for DL transmission, scheduling request, and CQI. A physical uplink shared channel (PUSCH) carries a UL-uplink shared channel (SCH).

FIG. 4 shows an example of a physical channel structure. A physical channel consists of a plurality of subframes in time domain and a plurality of subcarriers in frequency domain. One subframe consists of a plurality of symbols in the time domain. One subframe consists of a plurality of resource blocks (RBs). One RB consists of a plurality of symbols and a plurality of subcarriers. In addition, each subframe may use specific subcarriers of specific symbols of a corresponding subframe for a PDCCH. For example, a first symbol of the subframe may be used for the PDCCH. The PDCCH carries dynamic allocated resources, such as a physical resource block (PRB) and modulation and coding scheme (MCS). A transmission time interval (TTI) which is a unit time for data transmission may be equal to a length of one subframe. The length of one subframe may be 1 ms.

The transport channel is classified into a common transport channel and a dedicated transport channel according to whether the channel is shared or not. A DL transport channel for transmitting data from the network to the UE includes a broadcast channel (BCH) for transmitting system information, a PCH for transmitting a paging message, a DL-SCH for transmitting user traffic or control signals, etc. The DL-SCH supports HARQ, dynamic link adaptation by varying the modulation, coding and transmit power, and both dynamic and semi-static resource allocation. The DL-SCH also may enable broadcast in the entire cell and the use of beamforming. The system information carries one or more system information blocks. All system information blocks may be transmitted with the same periodicity. Traffic or control signals of a multimedia broadcast/multicast service (MBMS) may be transmitted through the DL-SCH or a multicast channel (MCH).

A UL transport channel for transmitting data from the UE to the network includes a random access channel (RACH) for transmitting an initial control message, a UL-SCH for transmitting user traffic or control signals, etc. The UL-SCH supports HARQ and dynamic link adaptation by varying the transmit power and potentially modulation and coding. The UL-SCH also may enable the use of beamforming. The RACH is normally used for initial access to a cell.

A MAC layer belongs to the L2. The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. A MAC sublayer provides data transfer services on logical channels.

The logical channels are classified into control channels for transferring control plane information and traffic channels for transferring user plane information, according to a type of transmitted information. That is, a set of logical channel types is defined for different data transfer services offered by the MAC layer. The logical channels are located above the transport channel, and are mapped to the transport channels.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting MBMS control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RLC layer belongs to the L2. The RLC layer provides a function of adjusting a size of data, so as to be suitable for a lower layer to transmit the data, by concatenating and segmenting the data received from a higher layer in a radio section. In addition, to ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides a retransmission function through an automatic repeat request (ARQ) for reliable data transmission. Meanwhile, a function of the RLC layer may be implemented with a functional block inside the MAC layer. In this case, the RLC layer may not exist.

A packet data convergence protocol (PDCP) layer belongs to the L2. The PDCP layer provides a function of header compression function that reduces unnecessary control information such that data being transmitted by employing IP packets, such as IPv4 or IPv6, can be efficiently transmitted over a radio interface that has a relatively small bandwidth. The header compression increases transmission efficiency in the radio section by transmitting only necessary information in a header of the data. In addition, the PDCP layer provides a function of security. The function of security includes ciphering which prevents inspection of third parties, and integrity protection which prevents data manipulation of third parties.

A radio resource control (RRC) layer belongs to the L3. The RLC layer is located at the lowest portion of the L3, and is only defined in the control plane. The RRC layer takes a role of controlling a radio resource between the UE and the network. For this, the UE and the network exchange an RRC message through the RRC layer. The RRC layer controls logical channels, transport channels, and physical channels in relation to the configuration, reconfiguration, and release of RBs. An RB is a logical path provided by the L1 and L2 for data delivery between the UE and the network. That is, the RB signifies a service provided the L2 for data transmission between the UE and E-UTRAN. The configuration of the RB implies a process for specifying a radio protocol layer and channel properties to provide a particular service and for determining respective detailed parameters and operations. The RB is classified into two types, i.e., a signaling RB (SRB) and a data RB (DRB). The SRB is used as a path for transmitting an RRC message in the control plane. The DRB is used as a path for transmitting user data in the user plane.

Referring to FIG. 3-(a), the RLC and MAC layers (terminated in the eNB on the network side) may perform functions such as scheduling, automatic repeat request (ARQ), and hybrid automatic repeat request (HARQ). The PDCP layer (terminated in the eNB on the network side) may perform the user plane functions such as header compression, integrity protection, and ciphering.

Referring to FIG. 3-(b), the RLC and MAC layers (terminated in the eNB on the network side) may perform the same functions for the control plane. The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

An RRC state indicates whether an RRC layer of the UE is logically connected to an RRC layer of the E-UTRAN. The RRC state may be divided into two different states such as an RRC connected state and an RRC idle state. When an RRC connection is established between the RRC layer of the UE and the RRC layer of the E-UTRAN, the UE is in RRC_CONNECTED, and otherwise the UE is in RRC_IDLE. Since the UE in RRC_CONNECTED has the RRC connection established with the E-UTRAN, the E-UTRAN may recognize the existence of the UE in RRC_CONNECTED and may effectively control the UE. Meanwhile, the UE in RRC_IDLE may not be recognized by the E-UTRAN, and a CN manages the UE in unit of a tracking area (TA) which is a larger area than a cell. That is, only the existence of the UE in RRC_IDLE is recognized in unit of a large area, and the UE must transit to RRC_CONNECTED to receive a typical mobile communication service such as voice or data communication.

In RRC_IDLE, the UE may receive broadcasts of system information and paging information while the UE specifies a discontinuous reception (DRX) configured by NAS, and the UE has been allocated an identification (ID) which uniquely identifies the UE in a TA and may perform public land mobile network (PLMN) selection and cell re-selection. Also, in RRC_IDLE, no RRC context is stored in the eNB.

In RRC_CONNECTED, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion.

When the user initially powers on the UE, the UE first searches for a proper cell and then remains in RRC_IDLE in the cell. When there is a need to establish an RRC connection, the UE which remains in RRC_IDLE establishes the RRC connection with the RRC of the E-UTRAN through an RRC connection procedure and then may transition to RRC_CONNECTED. The UE which remains in RRC_IDLE may need to establish the RRC connection with the E-UTRAN when uplink data transmission is necessary due to a user's call attempt or the like or when there is a need to transmit a response message upon receiving a paging message from the E-UTRAN.

The UE which remains in RRC_IDLE persistently performs cell reselection to find a better cell. In this case, the UE performs measurement and cell reselection by using frequency priority information. That is, the UE may determine which frequency will be preferentially considered when performing frequency measurement and cell reselection on the basis of the frequency priority information. The UE may receive the frequency priority information by using system information or an RRC connection release message. Or, the UE may receive the frequency priority information from another RAT in inter-RAT cell reselection.

Hereinafter, paging is described in detail. It may be referred to Section 8.5 of 3GPP TS 36.413 V11.5.0 (2013-09) and Section 5.3.2 of 3GPP TS 36.331 V11.5.0 (2013-09).

FIG. 5 shows a paging procedure between an MME and an eNB. In step S50, the MME initiates the paging procedure by transmitting the PAGING message to the eNB. At the reception of the PAGING message, the eNB shall perform paging of the UE in cells which belong to tracking areas as indicated in the List of TAIs IE. The CN Domain IE shall be transferred transparently to the UE. The Paging DRX IE may be included in the PAGING message, and if present the eNB shall use it. A list of closed subscriber group (CSG) IDs may be included in the PAGING message. If included, the E-UTRAN may use the list of CSG IDs to avoid paging the UE at CSG cells whose CSG ID does not appear in the list. For each cell that belongs to any of the TAs indicated in the List of TAIs IE, the eNB shall generate one page on the radio interface. The Paging Priority IE may be included in the PAGING message, and if present the eNB may use it.

Table 1 and Table 2 show an example of the PAGING message transmitted from the MME to the eNB.

TABLE 1

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | ignore |
| UE Identity Index value | M | | 9.2.3.10 | | YES | ignore |
| UE Paging Identity | M | | 9.2.3.13 | | YES | ignore |
| Paging DRX | O | | 9.2.1.16 | | YES | ignore |
| CN Domain | M | | 9.2.3.22 | | YES | ignore |
| List of TAIs | | 1 | | | YES | ignore |
| >TAI List Item | | 1 . . . | | | EACH | ignore |
| | | <maxnoofTAIs> | | | | |
| >>TAI | M | | 9.2.3.16 | | — | |
| CSG Id List | | 0 . . . 1 | | | GLOBAL | ignore |
| >CSG Id | | 1 . . . | 9.2.1.62 | | — | |
| | | <maxnoofCSGId> | | | | |
| Paging Priority | O | | 9.2.1.78 | | YES | ignore |

TABLE 2

| Range bound | Explanation |
|---|---|
| maxnoofTAIs | Maximum no. of TAIs. Value is 256. |
| maxnoofCSGIds | Maximum no. of CSG Ids within the CSG Id List. |
| | Value is 256. |

FIG. 6 shows a paging procedure between an E-UTRAN and a UE. In step S60, the E-UTRAN initiates the paging procedure by transmitting the Paging message to the UE at the UE's paging occasion. The E-UTRAN may address multiple UEs within a Paging message by including one PagingRecord for each UE. The E-UTRAN may also indicate a change of system rmation, and/or provide an ETWS notification or a CMAS notification in the Paging message.

Upon receiving the Paging message, the UE shall:

1> if in RRC_IDLE, for each of the PagingRecord, if any, included in the Paging message:

2> if the ue-Identity included in the PagingRecord matches one of the UE identities allocated by upper layers:

3> forward the ue-Identity and the cn-Domain to the upper layers;

1> if the systemInfoModification is included:

2> re-acquire the required system rmation using the system rmation acquisition procedure.

1> if the etws-Indication is included and the UE is ETWS capable:

2> re-acquire SystemInformationBlockType1 immediately, i.e., without waiting until the next system rmation modification period boundary;

2> if the schedulingInfoList indicates that SystemInformationBlockType10 is present:

3> acquire SystemInformationBlockType10;

2> if the schedulingInfoList indicates that SystemInformationBlockType11 is present:

3> acquire SystemInformationBlockType11;

1> if the cmas-Indication is included and the UE is CMAS capable:

2> re-acquire SystemInformationBlockType1 immediately, i.e., without waiting until the next system rmation modification period boundary;

2> if the schedulingInfoList indicates that SystemInformationBlockType12 is present:

3> acquire SystemInformationBlockType12;

1> if in RRC_IDLE, the eab-ParamModification is included and the UE is EAB capable:

2> consider previously stored SystemInformationBlockType14 as invalid;

2> re-acquire SystemInformationBlockType1 immediately, i.e., without waiting until the next system information modification period boundary;

2> re-acquire SystemInformationBlockType14 using the system information acquisition procedure;

Table 3 shows an example of the Paging message transmitted from the E-UTRAN to the UE.

TABLE 3
-- ASN1START
Paging ::= SEQUENCE {
pagingRecordList PagingRecordList OPTIONAL, -- Need ON
systemInfoModification ENUMERATED {true} OPTIONAL, -- Need ON
etws-Indication ENUMERATED {true} OPTIONAL, -- Need ON
nonCriticalExtension Paging-v890-IEs OPTIONAL -- Need OP
}
Paging-v890-IEs ::= SEQUENCE {
lateNonCriticalExtension OCTET STRING OPTIONAL, -- Need OP
nonCriticalExtension Paging-v920-IEs OPTIONAL -- Need OP
}
Paging-v920-IEs ::= SEQUENCE {
cmas-Indication-r9 ENUMERATED {true} OPTIONAL, -- Need ON
nonCriticalExtension Paging-v1130-IEs OPTIONAL -- Need OP
}
Paging-v1130-IEs ::= SEQUENCE {
eab-ParamModification-r11 ENUMERATED {true} OPTIONAL, -- Need
ON
nonCriticalExtension SEQUENCE { } OPTIONAL -- Need OP
}
PagingRecordList ::= SEQUENCE (SIZE (1..maxPageRec)) OF
PagingRecord
PagingRecord ::= SEQUENCE {
ue-Identity PagingUE-Identity,
cn-Domain ENUMERATED{ps, cs},
...
}
PagingUE-Identity ::= CHOICE {
s-TMSI S-TMSI,
imsi IMSI,
...
}
IMSI ::= SEQUENCE (SIZE (6..21)) OF IMSI-Digit
IMSI-Digit ::= INTEGER (0..9)
-- ASN1STOP

Referring to Table 3, the cmas-Indication fieldindicates indication of a CMAS notification, if present. The cn-Domain field indicates the origin of paging. The eab-ParamModification field indicates indication of an EAB parameters (SIB 14) modification, if present. The etws-Indication field indicates indication of an ETWS primary notification and/or ETWS secondary notification, if present. The imsi field indicates the international mobile subscriber identity, a globally unique permanent subscriber identity. The first element contains the first IMSI digit, the second element contains the second IMSI digit and so on. The systemInfoModtfication field indicates indication of a BCCH modification other than SIB 10, SIB11, SIB12 and SIB14, if present. The ue-Identity field provides the NAS identity of the UE that is being paged.

Category 0 UE or low complexity UE is described. Low complexity UEs are targeted to low-end (e.g., low average revenue per user, low data rate, delay tolerant) applications, e.g., some machine-type communications (MTCs). A low complexity UE indicates UE category 0 and may support the following:
Single receive antenna;
Type B half-duplex frequency division duplex (FDD) operation (optional);
Maximum UL-SCH/DL-SCH transport block size (TBS) of 1000 bits for unicast transmission/reception;
Maximum MCH TBS of 4584 bits, if it supports enhanced MBMS (eMBMS)

A category 0 UE may access a cell only if SIB1 indicates that access of category 0 UEs is supported. If the cell does not support access of category 0 UEs, a category 0 UE may consider the cell as barred and should not camp on it. The eNB may determine that a UE is in category 0 based on the UE capability. A UE indicating category 0 shall be able to receive up to 1000 bits for a transport block associated with cell radio network temporary identity (C-RNTI)/semi-persistent scheduling (SPS) C-RNTI/paging RNTI (P-RNTI)/system information RNTI (SI-RNTI)/random access RNTI (RA-RNTI) and up to 2216 bits for another transport block associated with P-RNTI/SI-RNTI/RA-RNTI.

When the eNB pages the category 0 UEs, it is likely to cause an increased failure rate for paging requests transmitted to category 0 UEs on the cell edge compared to other UEs on the cell edge, since the category OUE has only single receive antenna. This causes paging delay for the category 0 UE. In order to avoid the increased failure rate, the eNB may always page with the increased power since the eNB does not know whether there are category 0 UEs in the cell. This may cause power waste and interference to other cells.

Accordingly, a method for transmitting information on category 0 UEs for paging may be required. Hereinafter, a method for transmitting a paging message for category 0 UEs according to an embodiment of the present invention is described.

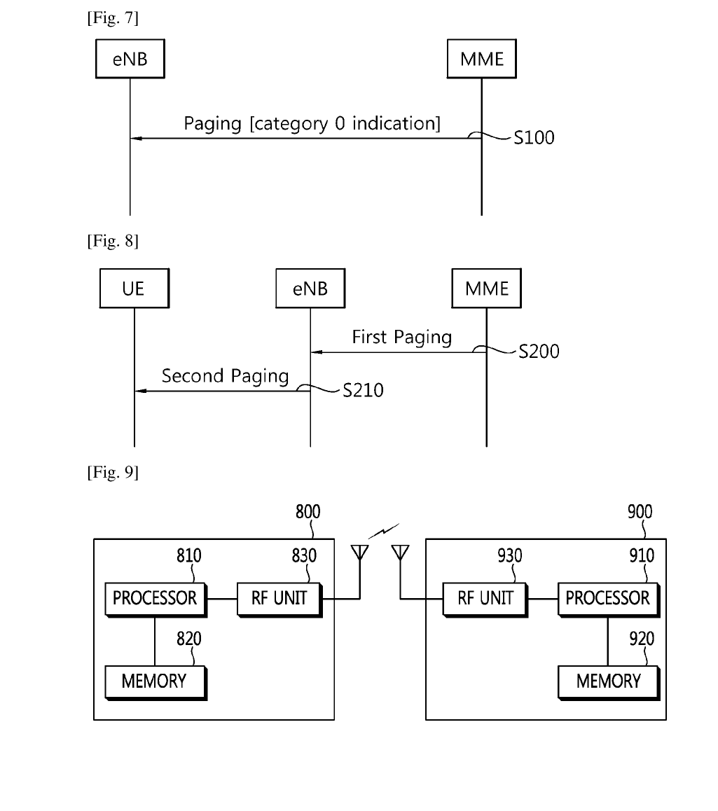

FIG. 7 shows an example of a method for transmitting a paging message according to an embodiment of the present invention. In step S100, the MME transmits a paging message including category 0 UE indication to the eNB, in order to avoid increased failure rate for paging for category 0 UEs. The category 0 UE indication may include at least one of following information:
The indication indicating whether the paged UE is category 0 UE
The paged UE's category
The indication indicating that the paged UE has limited bandwidth capability: In other words, the indication may indicate that UEs are needed to be scheduled only within a smaller bandwidth than 20 MHz.
The indication which indicates that the paged UE has limitation for maximum UL-SCH/DL-SCH TBS size for unicast/broadcast transmission/reception

Based on the received category 0 UE indication included in the paging message, the eNB may schedule paging messages for category 0 UEs using new P-RNTI specific to category 0 UEs within paging occasion specific to category 0 UEs. Accordingly, if the UE is category 0 UE, the UE monitors new P-RNTI specific to category 0 UEs within paging occasion specific to category 0 UEs. If the new P-RNTI, which may be called P-RNTI2, is indicated on PDCCH in UE's paging occasion, the UE receives paging message. The paging occasions specific to category 0 UEs may be a subset of paging occasions used for all the other UEs. The eNB informs paging occasions and paging cycle that are specific to category 0 UEs via one of MTC SIBs.

The category 0 UE indication according to an embodiment of the present invention may be the newly defined UE Radio Capability for Paging IE included in the PAGING message, which is described in FIG. 5 above. That is, according to an embodiment of the present invention, the MME may initiate the paging procedure by transmitting the PAGING message to the eNB. At the reception of the PAGING message, the eNB shall perform paging of the UE in cells which belong to tracking areas as indicated in the List of TAIs IE. The CN Domain IE shall be transferred transparently to the UE. The Paging DRX IE may be included in the PAGING message, and if present the eNB shall use it. A list of closed subscriber group (CSG) IDs may be included in the PAGING message. If included, the E-UTRAN may use the list of CSG IDs to avoid paging the UE at CSG cells whose CSG ID does not appear in the list. For each cell that belongs to any of the TAs indicated in the List of TAIs IE, the eNB shall generate one page on the radio interface. The Paging Priority IE may be included in the PAGING message, and if present the eNB may use it. If the UE Radio Capability for Paging IE is included in the PAGING message, the eNB may use it to apply specific paging schemes. The specific paging schemes may be paging for category 0 UEs.

Table 4 and Table 5 show an example of the PAGING message including the UE Radio Capability for Paging IE according to an embodiment of the present invention.

TABLE 4

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | ignore |
| UE Identity Index value | M | | 9.2.3.10 | | YES | ignore |
| UE Paging Identity | M | | 9.2.3.13 | | YES | ignore |
| Paging DRX | O | | 9.2.1.16 | | YES | ignore |
| CN Domain | M | | 9.2.3.22 | | YES | ignore |
| List of TAIs | | 1 | | | YES | ignore |
| >TAI List Item | | 1 . . . | | | EACH | ignore |
| | | <maxnoofTAIs> | | | | |
| >>TAI | M | | 9.2.3.16 | | — | |
| CSG Id List | | 0 . . . 1 | | | GLOBAL | ignore |
| >CSG Id | | 1 . . . | 9.2.1.62 | | — | |
| | | <maxnoofCSGId> | | | | |
| Paging Priority | O | | 9.2.1.78 | | YES | ignore |
| UE Radio Capability | O | | 9.2.1.98 | | YES | ignore |
| for Paging | | | | | | |

TABLE 5

| Range bound | Explanation |
|---|---|
| maxnoofTAIs | Maximum no. of TAIs. Value is 256. |
| maxnoofCSGIds | Maximum no. of CSG Ids within the CSG Id List. |
| | Value is 256. |

Referring to Table 4, the PAGING message includes the UE Radio Capability for Paging IE. Table 6 shows an example of the UE Radio Capability for Paging IE according to an embodiment of the present invention. The UE Radio Capability for Paging IE contains paging specific UE radio capability information.

TABLE 6

| IE/Group | | | IE Type and | |
|---|---|---|---|---|
| Name | Presence | Range | Reference | Semantics Description |
| UE Radio | M | | OCTET | Includes the UERadio- |
| Capability | | | STRING | PagingInformation |
| for Paging | | | | message. |

Referring to Table 6, the UE Radio Capability for Paging IE includes the UERadioPagingInformation message. Table 7 shows an example of the UERadioPagingInformation message according to an embodiment of the present invention. The UERadioPagingInformation message is used to transfer radio paging information required by category 0 UE, covering both upload to and download from the EPC.

TABLE 7
-- ASN1START
UERadioPagingInformation ::= SEQUENCE {
criticalExtensions CHOICE {
c1 CHOICE{
ueRadioPagingInformation-r12 UERadioPagingInformation-r12-IEs,
spare7 NULL,
spare6 NULL, spare5 NULL, spare4 NULL,
spare3 NULL, spare2 NULL, spare1 NULL
},
criticalExtensionsFuture SEQUENCE { }
}
}
UERadioPagingInformation-r12-IEs ::= SEQUENCE {
ue-RadioPagingInfo-r12 OCTET STRING (CONTAINING UE-Ra-
dioPagingInfo-r12),
nonCriticalExtension SEQUENCE { } OPTIONAL
}
-- ASN1STOP

Referring to Table 7, the UERadioPaginglnformation message includes the UERadioPagingInfo IE. Table 8 shows an example of the UE-RadioPagingInfo IE according to an embodiment of the present invention. The UE-RadioPagingInfo IE contains rmation needed for paging of category 0 UE.

TABLE 8

-- ASN1START
UE-RadioPagingInfo-r12 ::= SEQUENCE {
ue-Category-v12xy INTEGER (0) OPTIONAL,
...
}
-- ASN1STOP

Referring to Table 8, the UE-RadioPagingInfo IE has a value of 0, which indicates category 0 UEs. Accordingly, information on category 0 UEs for paging may be transmitted from the MME to the eNB.

According to the present invention, since the eNB can know whether the UE to be paged is category 0 UE or not, the eNB can optimize the transmission in order to take the UE receiver performance into account (e.g., by adapting the transmission power level or the number of multiplexed messages per transmission) in order to improve the system efficiency.

FIG. 8 shows another example of a method for transmitting a paging message according to an embodiment of the present invention.

In step S200, the MME transmits a first paging message, which includes an indication of UE capability for paging, to the eNB. The indication of UE capability for paging indicates whether a UE to be paged is a category 0 UE. The category 0 UE has a single receive antenna, and supports a TBS of maximum 1000 bits for the UL-SCH/DL-SCH transmission. The indication of UE capability for paging may further indicate a category of the UE to be paged. The indication of UE capability for paging may further indicate that the UE to be paged has limited bandwidth capability. The indication of UE capability for paging may further indicate that the UE to be paged has limitation for maximum TBS of a UL-SCH or a DL-SCH.

In step S210, the eNB transmits a second paging message to the UE based on the indication of UE capability for paging. The second paging message may be transmitted using a paging radio network temporary identity (P-RNTI) specified to the category 0 UE. Further, the second paging message may be transmitted within a paging occasion specified to the category 0 UE. The paging occasion specified to the category 0 UE may be a subset of a paging occasion used for all other UEs than the category 0 UE. The eNB may transmit information on a paging occasion and a paging cycle specified to the category 0 UE to the UE.

FIG. 9 is a block diagram showing wireless communication system to implement an embodiment of the present invention.

An MME 800 may include a processor 810, a memory 820 and a radio frequency (RF) unit 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

An eNB 900 may include a processor 910, a memory 920 and an RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

1.-15. (canceled)

16. A method for transmitting, by a mobility management entity (MME), a paging message in a wireless communication system, the method comprising:
transmitting a paging message, which includes an indication of user equipment (UE) capability for paging, to an eNodeB (eNB),
wherein the indication of UE capability for paging indicates whether a UE to be paged is a low cost UE.

17. The method of claim 16, wherein the low cost UE relates to machine-type communication (MTC).

18. The method of claim 16, wherein the indication of UE capability for paging further indicates a category of the UE to be paged.

19. The method of claim 18, wherein the category of the UE to be paged is a category 0 UE, and
the category 0 UE has a single receive antenna, and supports a transport block size (TBS) of maximum 1000 bits for a unicast uplink shared channel (UL-SCH) transmission or a unicast downlink shared channel (DL-SCH) reception.

20. The method of claim 16, wherein the indication of UE capability for paging further indicates that the UE to be paged needs to be scheduled within a limited bandwidth.

21. The method of claim 16, wherein the indication of UE capability for paging further indicates that the UE to be paged has limitation for maximum TBS of a UL-SCH or a DL-SCH.

22. A method for transmitting, by an eNodeB (eNB), a paging message in a wireless communication system, the method comprising:
receiving a first paging message, which includes an indication of user equipment (UE) capability for paging, from a mobility management entity (MME), wherein the indication of UE capability for paging indicates whether a UE to be paged is a low cost UE; and
transmitting a second paging message to the UE based on the indication of UE capability for paging.

23. The method of claim 22, wherein the low cost UE relates to machine-type communication (MTC).

24. The method of claim 22, wherein the indication of UE capability for paging further indicates a category of the UE to be paged.

25. The method of claim 24, wherein the category of the UE to be paged is a category 0 UE, and
the category 0 UE has a single receive antenna, and supports a transport block size (TBS) of maximum 1000 bits for a unicast uplink shared channel (UL-SCH) transmission or a unicast downlink shared channel (DL-SCH) reception.

26. The method of claim 22, wherein the second paging message is transmitted using a paging radio network temporary identity (P-RNTI) specified to the low cost UE.

27. The method of claim 22, wherein the second paging message is transmitted within a paging occasion specified to the low cost UE.

28. The method of claim 27, wherein the paging occasion specified to the low cost UE is a subset of a paging occasion used for all other UEs than the low cost UE.

29. The method of claim 22, further comprising:
transmitting information on a paging occasion and a paging cycle specified to the low cost UE to the UE.

30. An eNodeB (eNB) in a wireless communication system, the eNB comprising:
a radio frequency (RF) unit for transmitting or receiving a radio signal; and
a processor coupled to the RF unit, and configured to:
receive a first paging message, which includes an indication of user equipment (UE) capability for paging, from a mobility management entity (MME), wherein the indication of UE capability for paging indicates whether a UE to be paged is a low cost UE; and
transmit a second paging message to the UE based on the indication of UE capability for paging.
